(19) United States
(12) Patent Application Publication
(10) Pub. No.: US 2012/0124091 A1
(43) Pub. Date: May 17, 2012

(54) APPLICATION FILE SYSTEM ACCESS

(75) Inventors: Lyon Wong, Issaquah, WA (US); Scott D. Hoogerwerf, Seattle, WA (US); Manav Mishra, Kirkland, WA (US); Steven J. Ball, Seattle, WA (US); Samuel J. Moreau, Bellevue, WA (US); Jensen Harris, Bellevue, WA (US); Benjamin J. Karas, Seattle, WA (US); Kavitha Radhakrishnan, Redmond, WA (US); Rolf A. Ebeling, Kirkland, WA (US); Robert H. Liao, Bellevue, WA (US); Aaron W. Cardwell, Seattle, WA (US); Michael J. Gilmore, Bothell, WA (US)

(73) Assignee: MICROSOFT CORPORATION, Redmond, WA (US)

(21) Appl. No.: 12/945,573

(22) Filed: Nov. 12, 2010

(51) Int. Cl. G06F 17/30; G06F 3/048

(52) U.S. Cl. 707/783; 715/854; 707/E17.005

(57) ABSTRACT

Application file system access techniques are described. In implementations, a request is received by one or more modules via an application programming interface from an application that is executed on the computing device to access a file system of a computing device. A portion is exposed in a user interface by the one or more modules, the portion having an option that is selectable by a user to confirm that access is to be granted, the portion exposed such that the application is not aware of what is contained in the portion. Responsive to selection of the option, access is granted to the application by the one or more modules such that the application is not aware of where in the file system the access is granted.

### BACKGROUND

Users have access to a wide range of applications from a wide variety of different sources. For example, users traditionally obtained an application from a “bricks and mortar” store on a computer-readable storage medium (such as an optical disc) and then installed the application on the user's home computing device. These applications were generally provided by reputable developers and thus were considered trustworthy.

Subsequent techniques were then developed in which the user accessed a network to locate and install an application. For example, an application marketplace may be made available for access via the Internet to locate and purchase applications. In some instances, the application marketplace may include a multitude of applications, which may originate from a variety of different developers. Because of the sheer number of applications that may be made available and the variances in the developers that may provide them, however, the functionality of the applications may have varying degrees of trustworthiness. For example, the applications may have flawed functionality, may have been written by malicious parties, and so on.

### SUMMARY

Application file system access techniques are described. In implementations, a request is received by one or more modules via an application programming interface from an application that is executed on a computing device to access a file system of the computing device. A portion is exposed in a user interface by the one or more modules, the portion having an option that is selectable by a user to confirm that access is to be granted, the portion exposed such that the application is not aware of what is contained in the portion. Responsive to selection of the option, access is granted to the application by the one or more modules such that the application is not aware of where in the file system the access is granted.

In one or more implementations, a user interface is output by a computing device responsive to a request by an application executed by the computing device, the user interface including one or more visual affordances configured to provide navigation through a file system of the computing device without enabling the application to access the file system directly. Responsive to receipt of an input indicating navigation through the file system, the one or more visual affordances are updated in the user interface.

In one or more implementations, one or more computer readable storage media comprise instructions stored thereon that responsive to execution by a computing device, cause the computing device to perform operations that include receiving a request by a broker module via an application programming interface from an application that is executed on the computing device to access a file system of the computing device. In response, the broker module causes a user interface of the computing device to provide navigation through a file system of the computing device without enabling the application to access the file system directly, the navigation configured to verify that access performed by a user through interaction with the user interface is to be granted to the application as requested.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform techniques described herein.

FIG. 2 is an illustration of a system in an example implementation configured to perform file management.

FIG. 3 depicts an example implementation of a computing device of FIG. 1 configured as a mobile communication device and as outputting a user interface having visual affordances that are configured to aid access to a file system.

FIG. 4 is an illustration of an example implementation of a computing device of FIG. 3 as employing a visual affordance of a landmark in a user interface to aide navigation through a file system.

FIG. 5 is an illustration of an example implementation of the computing device of FIG. 1 as employing a visual affordance of a signpost in a user interface to aide navigation through a file system.

FIG. 6 is an illustration of an example implementation of the computing device of FIG. 1 as displaying a user interface that employs a visual affordance of an index bar to aide navigation through a file system.

FIG. 7 is an illustration of a user interface in an example implementation of the computing device of FIG. 1 as displaying a user interface configured to save files to a file system.

FIG. 8 is a flow diagram depicting a procedure in an example implementation in which access to a file system by an application is managed.

FIG. 9 is a flow diagram depicting a procedure in an example implementation in which one or more visual affordances are leveraged in a user interface to aide navigation through a file system.

### DETAILED DESCRIPTION

### Overview

With the proliferation of application developers, users of computing device are exposed to an ever increasing multitude of applications. However, the trustworthiness of these applications may vary as greatly as the developers that write them. Consequently, traditional file systems that granted unencumbered access may cause the computing device to be compromised by flawed and even malicious applications.

Application file system access techniques are described. In implementations, a broker module is utilized to manage access by an application to a file system to access local files, networked computers, and/or peripheral devices communicatively coupled to a computing device. For example, the broker module may be configured to cause output of a user interface. Via the user interface, a user may verify a request by an application to access the file system. In this way, the broker module may help a user to manage access that is to be granted to applications that execute on the computing device and therefore protect against untrustworthy applications. The user interface may also be configured to include a variety of different visual affordances to aide navigation through the user interface. Further discussion of the broker module and corresponding user interface may be found in relation to the following sections.

In the following discussion, an example environment is first described that is operable to perform techniques described herein. Examples procedures are then described, which are operable in the example environment as well as in other environments. Likewise, the example environment is not limited to performance of the example procedures.

Example Environment

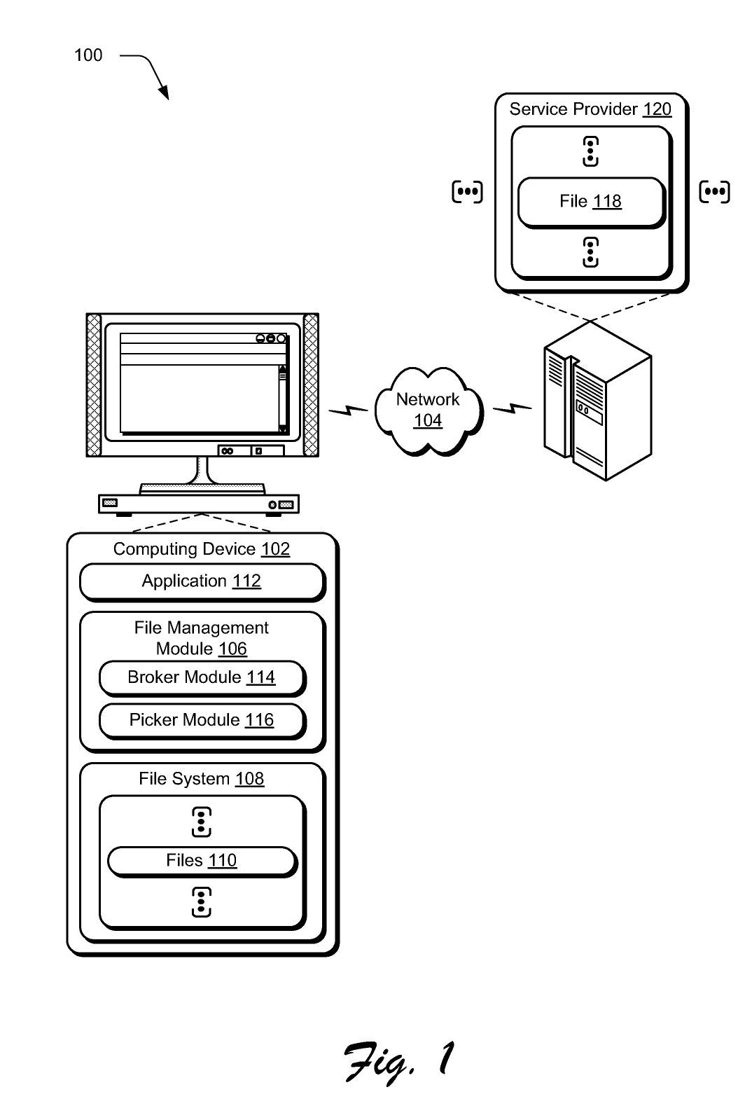

FIG. 1 is an illustration of an environment 100 in an example implementation that is operable to employ file system access techniques described herein. The illustrated environment 100 includes a computing device 102, which may be configured in a variety of ways. For example, the computing device 102 may be configured as a computer that is capable of communicating over a network 104, such as a desktop computer, a mobile station, an entertainment appliance, a set-top box communicatively coupled to a display device, a wireless phone, a game console, and so forth.

The computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations, a remote control and set-top box combination, an image capture device (e.g., camera) and a game console configured to capture gestures, and so on.

The computing device 102 may also include an entity (e.g., software) that causes hardware of the computing device 102 to perform operations, e.g., configures processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform the operations. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via the network 104. The computer-readable medium may also be configured as a computer-readable storage medium and thus is not a signal bearing medium. Examples of a computer-readable storage medium include a random-access memory (RAM), read-only memory (ROM), optical discs, flash memory, hard disk memory, and other memory devices that may use magnetic, optical, and other techniques to store instructions and other data.

Although the network 104 is illustrated as the Internet, the network may assume a wide variety of configurations. For example, the network 104 may include a wide area network (WAN), a local area network (LAN), a wireless network, a public telephone network, an intranet, and so on. Further, although a single network 104 is shown, the network 104 may be configured to include multiple networks.

The computing device 102 is illustrated as including a file management module 106. The file management module 106 is representative of functionality to manage a file system 108. The file management module 106 may be implemented in a variety of ways, such as a stand-alone application, as part of an operating system of the computing device 102, and so on.

The file system 108 employs techniques to organize and store files 110 by the computing device 102. The file system 108, for instance, may employ a hierarchy of folders to manage files 110 (e.g., executable and/or library files) in storage. The file system 108 may also employ a namespace, which provides techniques to manage a context in which the files 110 may be organized using abstractions. A variety of other file management techniques that may be employed by the file management module 106 and file system 108 are contemplated.

Additionally, a variety of different files 110 may be managed using the file management module 106. For example, the files 110 may be configured as library files. Library files generally refer to a unit of data that is referenced by another file that executes on the computing device 102, such as an application 112. Thus, the application 112 is an executable file that may access a library file to process the data contained therein. Accordingly, a library file may assume a variety of configurations, such as a document, plug-in, script, and so forth. Likewise, the application 112 may also assume a variety of configurations, such as a word processor, spreadsheet application, browser, and so on.

The file management module 106 is further illustrated as including a broker module 114 and a picker module 116. The broker module 114 is representative of functionality of the file management module 106 to manage access of the application 112 to the file system 108. The broker module 114, for instance, may act as an intermediary to locate files 110 requested by the application 112 and provide the files 110 back to the application 112. Further, the files 110 may be provided without the application 112 “knowing” from where the files 110 were obtained, e.g., with the application 112 being aware of the namespace used by the file system 108.

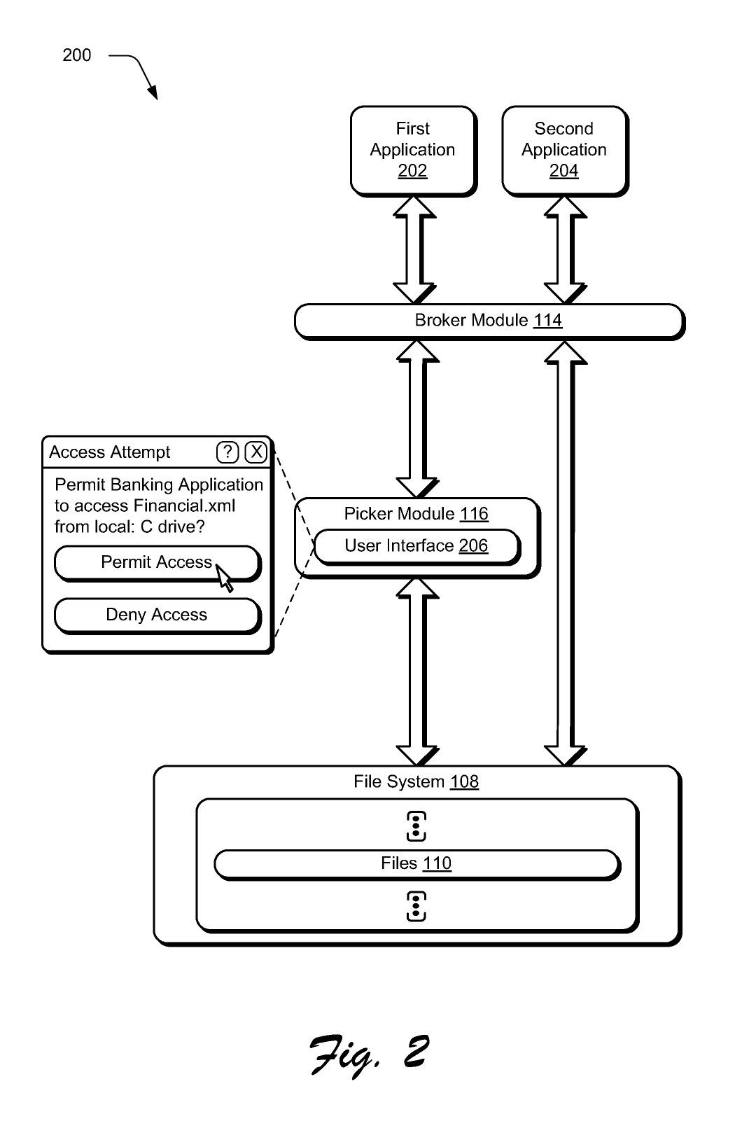

Additionally, the broker module 114 may employ the picker module 116 to configure a user interface such that a user may verify that access to the file system 108 is to be granted. In this way, the picker module 116 may allow a user to verify that the application 112 is accessing files as intended, further discussion of which may be found in relation to FIG. 2. Further, although access to files 110 that are local to the computing device 102 is described, the file management module 106 may manage the file system 108 to control access to remote files 118 that are accessible via a service provider 120 over the network (e.g., implemented using one or more computing devices), peripheral devices that are communicatively coupled to the computing device 102, and so on.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

FIG. 2 is an illustration of a system 200 in an example implementation configured to perform file management. The system 200 as illustrated may be implemented by the file management module 106 of the computing device 102 to perform file management techniques. For example, the file management module 106 may be incorporated as part of an operating system, an application that executes in conjunction with the operating system, a stand-alone application, and so on. Regardless of where incorporated, the file management module 106 may employ techniques to manage files 110, 118 accessible to the computing device 102 locally and/or remotely via the network 104, e.g., from the service provider 120.

The system 200 as illustrated includes a first application 202 and a second application 204, which may or may not correspond to the application 112 described in relation to FIG. 1. In this example, both the first and second applications 202, 204 communicate with the broker module 114 via one or more application programming interfaces to access the file system 108.

In the case of the second application 204, a determination has been made that access to the file system 108 is trusted or in other words, the second application 204 is trustworthy. For example, the second application 204 may be coded by a reputable software provider, tested for compatibility, and so on. Accordingly, the second application 204 may be permitted by the broker module 114 to access the file system 108 without verification by the picker module 116.

In one implementation, this access is permitted without the second application 204 “knowing” where and/or how particular files 110 are arranged in the file system 108. The second application 204, for instance, may be unaware of a namespace used to access the files 110 in the file system 108. Therefore, the broker module 114 may convert requests from the second application 204 received via the API into a form that are understandable to locate files 110 of interest. In this way, the broker module 114 may still protect and manage access granted to the second application 204.

In another implementation, the second application 204 may be made aware of where and/or how the files 110 are arranged and located within the file system 108. For instance, the second application 204 may be configured to use a namespace supported by the file system 108 such that conversion of the request is not performed by the broker module 114. A variety of other examples are also contemplated, such as to enable direct access to the file system 108 without interacting with the broker module 114 to fully-trusted applications.

In the case of the first application 202 in the example illustrated in FIG. 2, a determination may be made that access to the file system 108 is not trusted, e.g., partially trusted or not permitted whatsoever. In response, the broker module 114 may employ the picker module 116 to verify access to the file system 108 that is requested by the first application 202. The first application 202, for instance, may communicate a request via one or more APIs to the broker module 114 to access the file system 108.

The broker module 114, upon receiving this request, may implement the picker module 116 to generate a user interface 206. The user interface 206 in this example is shown as a portion that includes a description of what access is being request and “what” is requesting the access, e.g., identify the first application 202. The user interface 206 is also illustrated as including an option (e.g., “permit access” button) that is selectable to permit the requested access. An option to deny the access (e.g., “Deny Access” button) is also included in the user interface 206. Information within the portion of the user interface 206 may be output such that the first application 202 is not aware of what is contained therein and therefore is not made aware of a location of the requested data.

If the user selects the option to permit access (e.g., which is illustrated as selecting the Permit Access button using a cursor control device), the picker module 116 may permit access to the requested file 110. A variety of different types of access may be managed by the broker and picker modules 114, 116, singly or in combination. Examples of such access including saving a file 110, opening a file 110, modifying a file 110, moving files 110, and so forth.

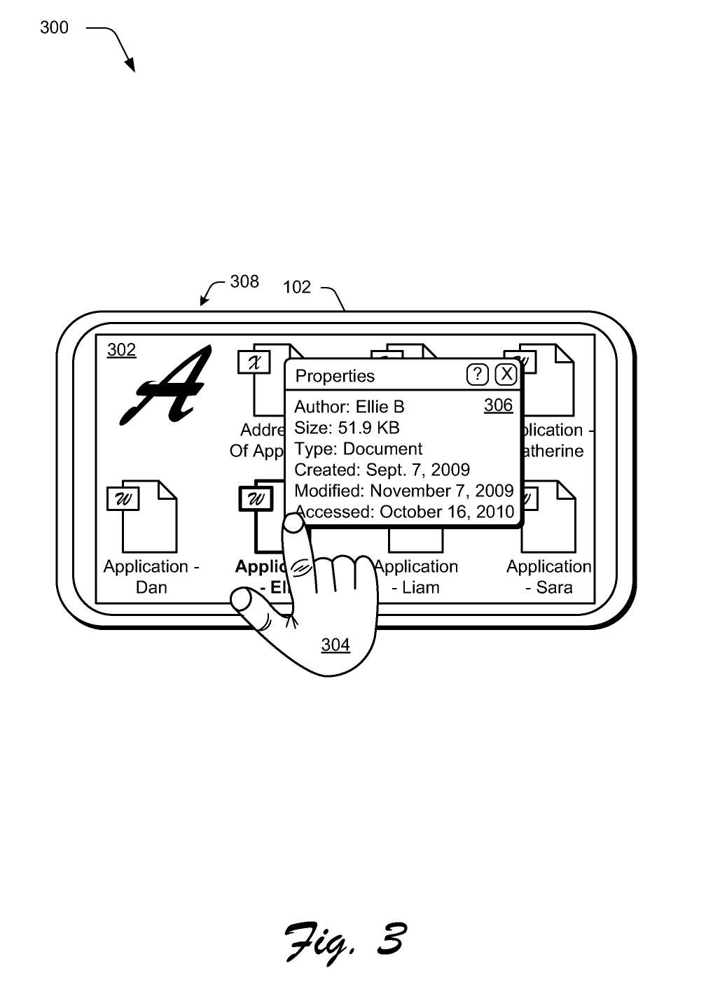

The picker module 116 may be configured to provide access to the files 110 via the broker module 114 to the first application 202 in a way such that the first application 202 is unaware of a namespace used by the file system 108 to manage the files 110. Thus, the picker module 116 may protect the file system 108 from access by untrustworthy applications by confirming this access via the user interface 206. Examples of different configurations of user interfaces that may be used to interact with the file system 108 may be found in relation to FIGS. 3-7.

In one or more implementations, the broker module 114 may oversee a plurality of picker modules 116, each configured for a respective one of a plurality of applications. Thus, the broker module 114 and the picker module 116 may provide techniques to manage access to the files 110 by the first and second applications 202, 204 while reducing a likelihood that the execution of the applications may compromise the computing device 102 and/or other computing devices, e.g., one or more computing devices that implement the service provider 120 of FIG. 1.

Example User Interfaces

The following section describes example user interfaces that may be implemented utilizing the previously described systems and devices. The computing device 102, for instance, may output the user interface 206 through execution of instructions on hardware of the computing device, e.g., one or more processors and/or functional blocks that are configured to perform operations by the instructions. Although these techniques are described for output by the user interface 206 of the picker module 116, these techniques may be employed by a wide variety of different user interfaces without departing from the spirit and scope thereof.

FIG. 3 depicts an example implementation 300 of the computing device 102 of FIG. 1 configured as a mobile communication device and as outputting a user interface 302 having visual affordances that are configured to aid access to the file system 108. The user interface 302, as previously described, may be output to provide access to files 110 in the file system 108. Accordingly, the user interface 302 may be configured to support navigation through the file system 108 in response to user inputs such that the user may manage how this access is performed. To aide this navigation, the user interface 302 may employ a variety of different visual affordances.

For example, the user interface 302 generated by the picker module 116 may support a gesture to determine properties of a represented file in the user interface 302. A finger of a user's hand 304, for instance, may be placed over a display of a representation of a file (e.g., “Application—Ellie”) to cause an output of a portion 306 in the user interface 302. The portion 306 may describe properties of the represented file, such as author, size, type, date created, date modified, date accessed, and so on. In an implementation, the output of the portion 306 may be performed “just-in-time” upon detection of the gesture. The gesture may be detected by the computing device 102 in a variety of ways, such as using touchscreen functionality, one or more cameras, and so on.

The user interface 302 also includes another example of a visual affordance, which may be referred to as a landmark. A landmark is an object included in the user interface 302 that is configured to describe a characteristic of a group of items currently being displayed. In the illustrated example, the landmark 308 is a letter “A” which references a portion of an alphabet that corresponds to files that are currently being displayed. In this way, a user of the computing device 102 may be readily informed as to “where” the user is located within the user interface 302. Thus, this technique may be used to readily apprise a user of a current location in a relatively large group of files 108, an example of which may be found in relation to the following figure.

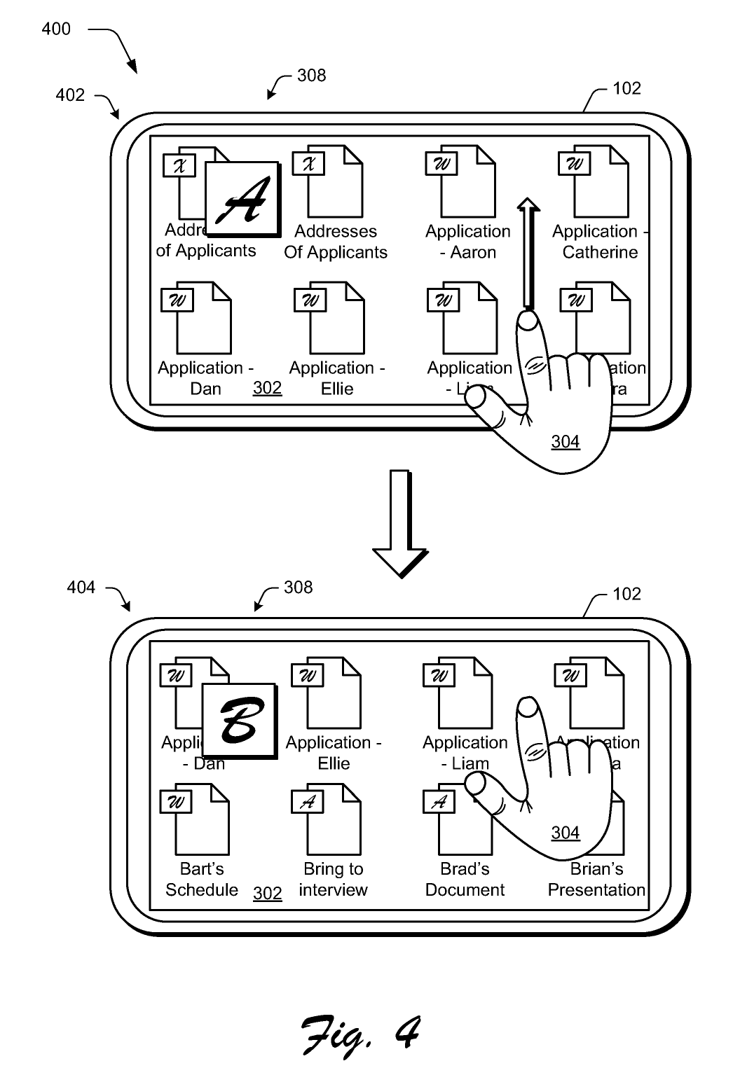

FIG. 4 depicts an example implementation 400 of the computing device 102 of FIG. 3 as employing a visual affordance of a landmark in a user interface to aide navigation through a file system 108. The example implementation is illustrated through use of first and second stages 402, 404.

At the first stage 402, a landmark 308 is illustrated as displaying a letter “A,” which corresponds to currently displayed representations of files in the user interface 302 as described in relation to FIG. 3. A finger of the user's hand 304 is also illustrated as performing a pan gesture, which in this case involves a “tap-and-slide” movement of the finger of the user's hand 304 across a display device of the computing device 102 as illustrated by the arrow.

At the second stage 402, a result of the pan gesture is shown. In this example the user interface 302 was scrolled upward to display files that begin with the letter “B.” In response, the landmark 308 is also configured by the picker module 116 to display a letter “B.” In an implementation, the landmark 308 “hovers” over a display of the representations of the files in the user interface 302 such that the representations of the files may scroll beneath the landmark 308 while the landmark 308 remains stationary in the user interface 302. In this way, a user may readily determine a current location within a large group of files, characteristics of a group of files currently displayed, and so on. Other techniques are also contemplated to indicate a current location within a group of files, another example of which may be found in relation to the following figure.

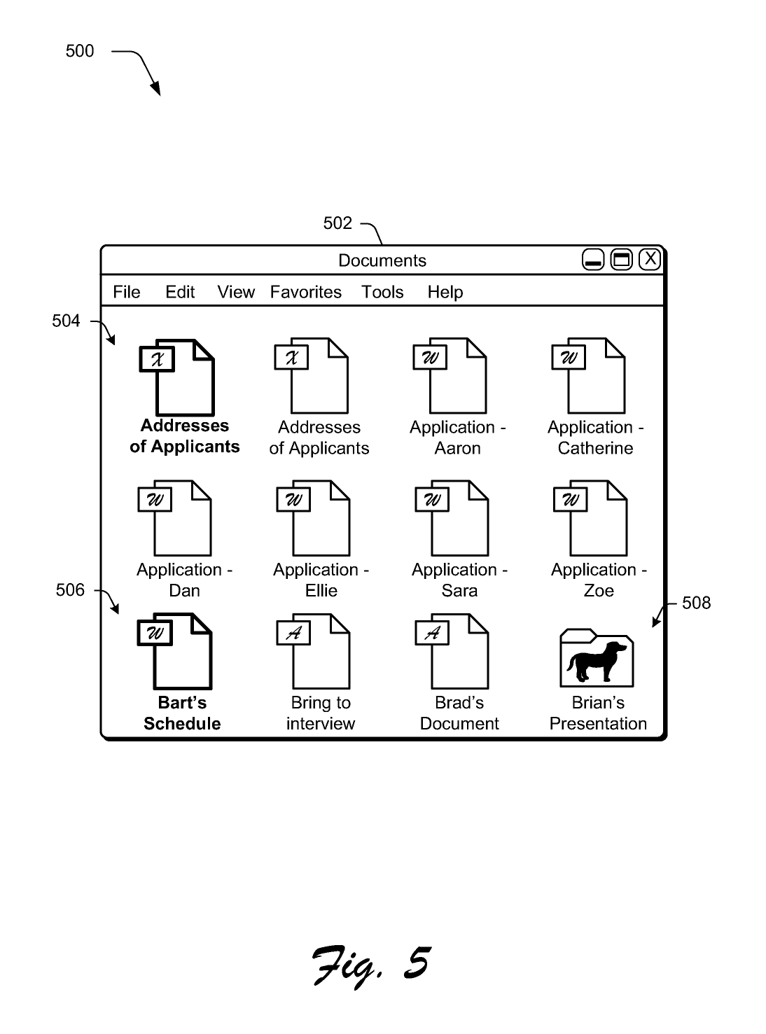

FIG. 5 depicts an example implementation 500 of the computing device 102 of FIG. 1 as employing a visual affordance of a signpost in a user interface to aide navigation through a file system 108. In the previous example, the landmark 308 was configured as a separate item in the user interface to represent a characteristic shared by items currently being displayed in the user interface. In this example, the user interface 502 includes signposts 504, 506 that are configured from the representations of the files themselves to indicate a characteristic, such as a current location within the user interface 502.

For example, a display characteristic of the signposts 504, 506 may be changed with respect to other representations of files to capture a user's attention. In the illustrated example bolding is used but other display characteristics may be utilized, such as size, color change, underlining, highlighting, use of animations, size change, and so on. Thus, the characteristic of the representation itself may be changed from how it would have been otherwise displayed in the user interface.

In the illustrated user interface 502, the signposts 504, 506 are provided for different groups of files that begin with a matching letter. However, other groupings are also contemplated, such as based on type of file or other properties that may be shared by one or more files 110. Thus, in this example the visual affordance (e.g., the signpost) aides a user in finding a location in the user interface, determining characteristics of groups of represented files, and so on. A variety of other visual affordances may also be utilized by the user interface 502 to inform a user regarding characteristics of files contained therein.

One such example is a visual affordance in the user interface 502 that causes a representation 508 of a file to display contents of the file. In the illustrated example, the representation 508 is illustrated as indicating that the folder “Brian's Presentation” includes an image of a dog. The image may be taken from a variety of different types of files, such as a title page of a presentation file, an image file itself, and so on. Additionally, a variety of different techniques may be employed to determine which image is representative of files in the folder, such as to examine metadata, based on number of occurrences of the image in the folder, and so on.

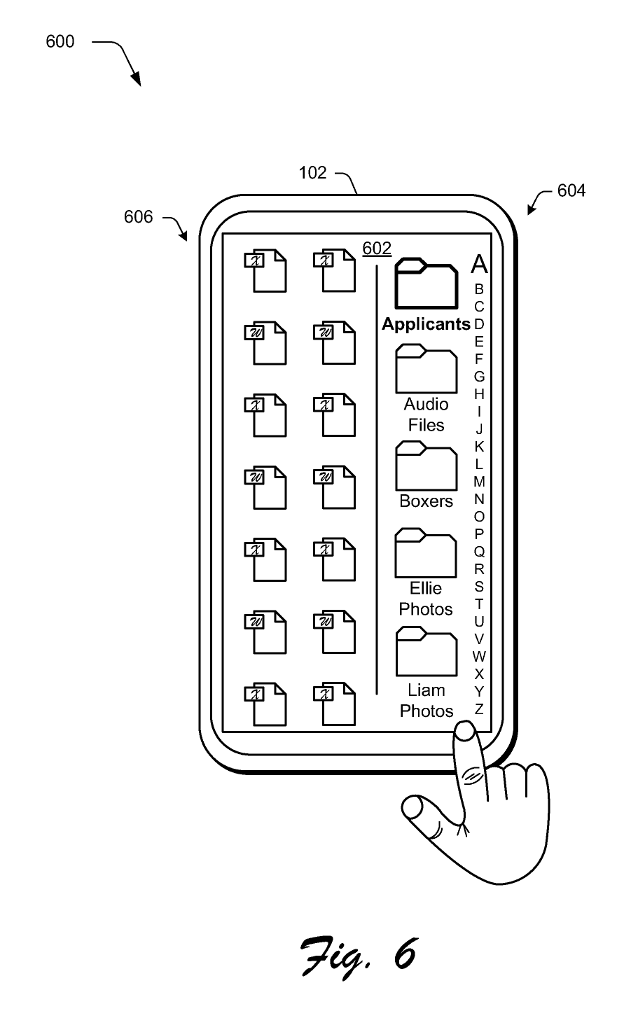

FIG. 6 depicts an example implementation 600 of the computing device 102 of FIG. 1 as displaying a user interface 602 that employs a visual affordance of an index bar 604 to aide navigation through a file system 108. In this example, the user interface 602 includes a portion having representations of files. The user interface 602 also includes an index bar 604 that is configured to navigate between folders in the file system 108.

For example, the index bar 602 may include a listing of letters and employ techniques to indicate “where” in the arrangement of letters the index bar 604 is located. In the illustrated instance, both a representation of a folder “Applicants” and a letter “A” are bolded, although other display characteristics may also utilized.

Thus in this example, the indication of “where” describes a characteristic of files that are currently represented in the user interface 602, e.g., a location in alphabetically arranged folders. The index bar 604 may be navigated in a variety of ways, such as by using a cursor control device, use of a gesture as illustrated to select a folder and/or letter from the bar, and so on. Although in this example a user interface 602 was shown as having the index bar 604 separated to perform navigation through folders from representations that are included in a selected folder, the index bar 604 may be employed in a variety of different user interfaces, such as to navigate between representations of files themselves.

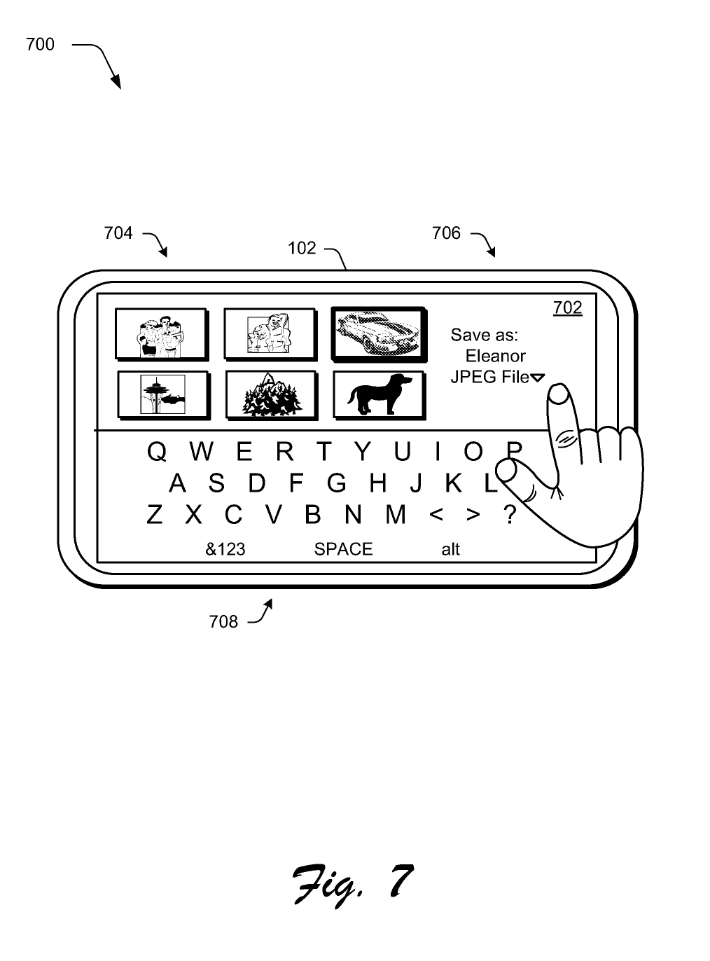

FIG. 7 depicts an example implementation 700 of the computing device 102 of FIG. 1 as displaying a user interface configured to save files to a file system. In this example, a user interface 702 is configured by the computing device 102 to save a file to the file system 108. The user interface 702 includes a portion 704 that includes representations of files, which are images in this instance. A representation of a car is illustrated as being selected to save to the file system 108.

The user interface 702 also includes a portion 706 that is configured to specify information about the file to be saved, which in this instance is a name “Eleanor” and a type of file. A soft keyboard 708 is further displayed that is configured to receive touch inputs to enter data into the save portion 706. In this way, a user may navigate through a user interface, specify a file to be saved, enter information that is to be used to save the file, and have the file saved through interaction with the user interface 702 yet still limit access by the application 112 to the file system 108. Further discussion of application file system access techniques may be found in relation to the following procedures.

Example Procedures

The following discussion describes file management techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interfaces 200-700 of FIGS. 2-7.

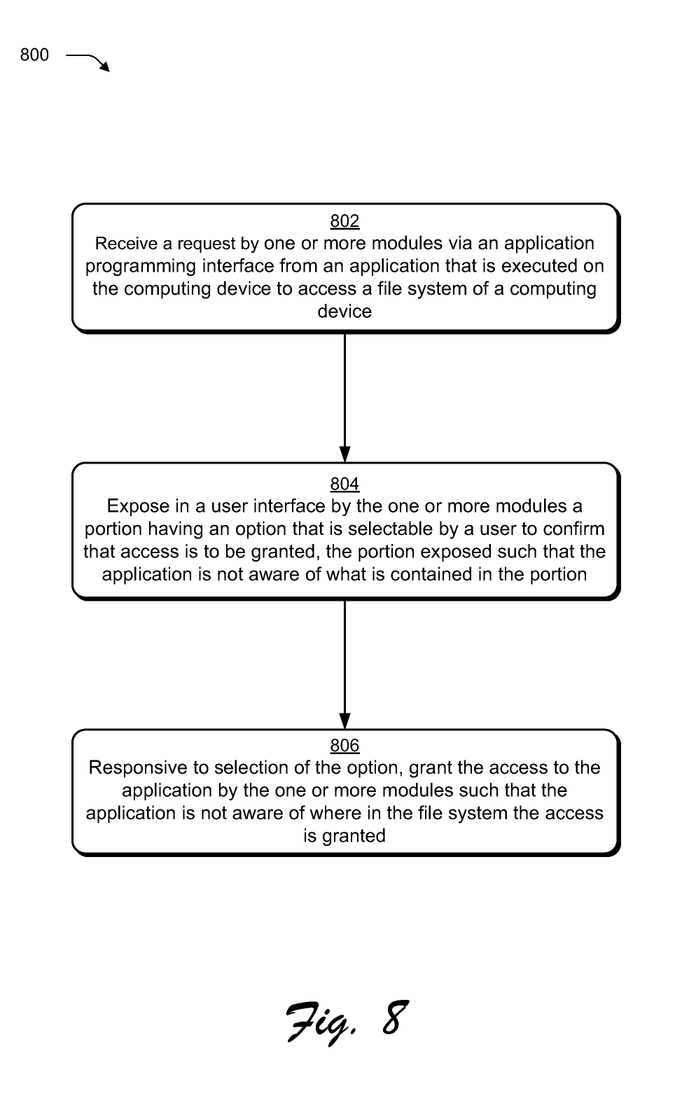

FIG. 8 depicts a procedure 800 in an example implementation in which access to a file system by an application is managed. A request is received by one or more modules via an application programming interface from an application that is executed on a computing device to access a file system of the computing device (block 802). The application 112, for instance, may desire to open a file, save a file, modify a file, and so on. Accordingly, the application 112 may communicate a request via an API to a broker module 114.

A portion in a user interface is exposed by the one or more modules having an option that is selectable by a user to confirm that access is to be granted, the portion exposed such that the application is not aware of what is contained in the portion (block 804). Continuing with the previous example, the broker module 114 may cause the picker module 116 to output a user interface 206. The user interface 206 is configured to notify a user that the access is requested and have the user verify that the access is permitted. The user interface 206, for instance, may describe what application is requesting the access and what access is being requested.

Responsive to selection of the option, access is granted to the application by the one or more modules such that the application is not aware of where in the file system the access is granted (block 806). The picker module 116, for instance, may permit access to the files 110 by acting as an intermediary such that the application is not aware of a namespace used by the file system 108. A variety of other examples are also contemplated.

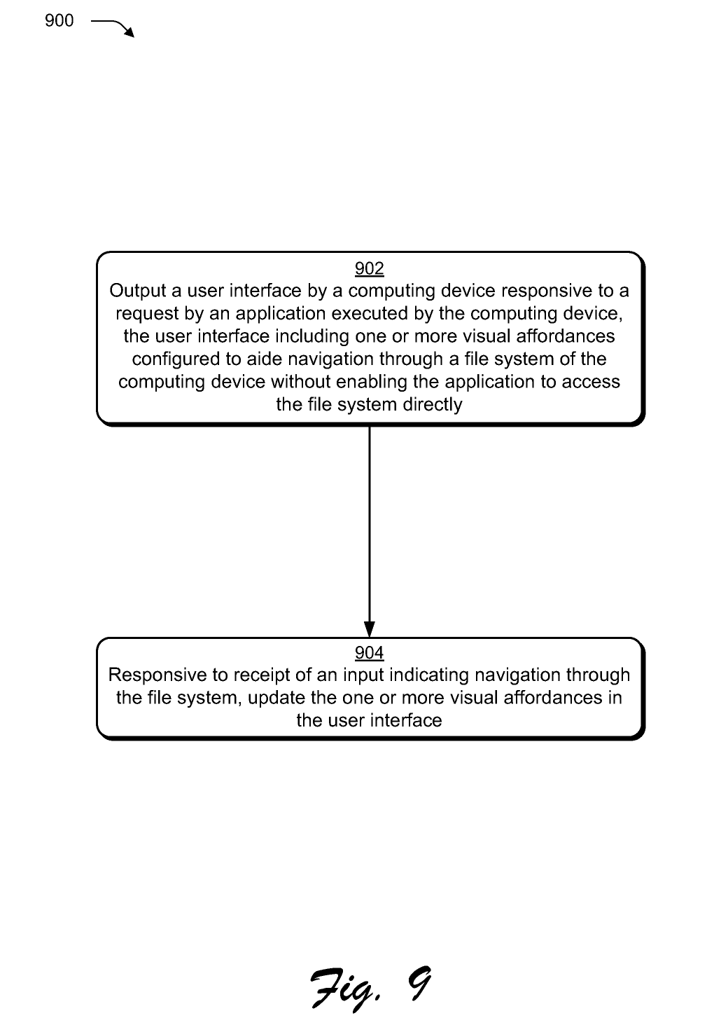

FIG. 9 depicts a procedure 900 in an example implementation in which one or more visual affordances are leveraged in a user interface to aide navigation through a file system. A user interface is output by a computing device responsive to a request by an application executed by the computing device, the user interface including one or more visual affordances configured to provide navigation through a file system of the computing device without enabling the application to access the file system directly (block 902). A variety of different visual affordances may be employed by the user interface, examples of which may be found in relation to FIGS. 3-7. These affordances may be utilized to navigate through the file system 108 without allowing the application to access the file system 108 directly (e.g., by employing a namespace and direct communication) but rather indirectly, such as through a broker module 114.

Responsive to receipt of an input indicating navigation through the file system, the one or more visual affordances are updated in the user interface (block 904). The visual affordances of the landmark, signpost, folders, index bar, and so on may be updated as a user navigates through the file system for a variety of different purposes, such as to display characteristics of files that are currently represented in the user interface. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving a request by one or more modules via an application programming interface from an application that is executed on a computing device to access a file system of the computing device;
exposing in a user interface by the one or more modules a portion having an option that is selectable by a user to confirm that access is to be granted, the portion exposed such that the application is not aware of what is contained in the portion; and
responsive to selection of the option, granting the access to the application by the one or more modules such that the application is not aware of where in the file system the access is granted.

2. A method as described in claim 1, wherein the portion identifies data in the file system to which access is to be granted and a location of the data in the file system, both of which are exposed in the portion such that the application is not aware of either one.

3. A method as described in claim 1, wherein the access is to save data to storage managed by the file system.

4. A method as described in claim 1, wherein the access is to obtain data from storage managed by the file system for processing by the application.

5. A method as described in claim 1, wherein the access is to another computing device that is networked to the computing device

6. A method as described in claim 1, wherein the access is to a peripheral device communicatively coupled to the computing device.

7. A method as described in claim 1, wherein the user interface includes one or more visual affordances configured to enable navigation through the file system without the application being aware of the navigation.

8. A method as described in claim 7, wherein at least one said visual affordance is configured to show properties of an item of data selected via the user interface responsive to selection of the item.

9. A method as described in claim 7, wherein at least one said visual affordance is configured to perform the navigation responsive to one or more gestures.

10. A method as described in claim 1, wherein the application is limited to access to the file system through the one or more modules and is thus prevented from direct access to the file system.

11. A method as described in claim 1, further comprising determining whether the application is to be trusted with direct access to the file system and the receiving is performed responsive to a determination that the application is not to be trusted with direct access to the file system.

12. A method comprising:
outputting a user interface by a computing device responsive to a request by an application executed by the computing device, the user interface including one or more visual affordances configured to provide navigation through a file system of the computing device without enabling the application to access the file system directly; and
responsive to receipt of an input indicating navigation through the file system, updating the one or more visual affordances in the user interface.

13. A method as described in claim 12, wherein at least one of the visual affordances is configured for interaction using a gesture.

14. A method as described in claim 12, wherein the user interface is configured to confirm by a user that interacts with the user interface that access to the file system is to be granted as requested by the application.

15. A method as described in claim 12, wherein at least one said visual affordance is a landmark that indicates a characteristic of a group of items currently displayed in the user interface.

16. A method as described in claim 15, wherein the landmark is configured to:
hover over a display of items in the user interface as the display of items is scrolled; and
display a corresponding said characteristic to the items that are currently displayed below the landmark.

17. A method as described in claim 12, wherein at least one said visual affordance is a signpost that involves applying a characteristic to a display of a representation of an item in the user interface to indicate that the representation is to draw attention to a group of a plurality of items in the user interface.

18. A method as described in claim 12, wherein at least one said visual affordance involves selection of an icon via a tap-and-hold gesture to cause a just-in-time output of properties of a file that corresponds to the icon in the user interface.

19. One or more computer readable storage media comprising instructions stored thereon that responsive to execution by a computing device, causes the computing device to perform operations comprising:
receiving a request by a broker module via an application programming interface from an application that is executed on the computing device to access a file system of the computing device; and
responsive to the receiving, causing, by the broker module, a user interface of the computing device to provide navigation through a file system of the computing device without enabling the application to access the file system directly, the navigation configured to verify that access performed by a user through interaction with the user interface is to be granted to the application as requested.

20. One or more computer readable storage media as described in claim 19, wherein the user interface including one or more visual affordances to aid the navigation, in which:
at least one said visual affordance is a landmark that indicates a characteristic of a group of items currently displayed in the user interface;
another said visual affordance is a signpost that involves applying a characteristic to a display of a representation of an item in the user interface to indicate that the representation is to draw attention to a group of a plurality of items in the user interface; and
a further said visual affordance involves selection of an icon via a gesture to cause a just-in-time output of properties of a file that corresponds to the icon in the user interface.
